(19) United States
(12) Patent Application Publication
(10) Pub. No.: US 2023/0103854 A1
(43) Pub. Date: Apr. 6, 2023

(54) POLYOLEFIN/ POLYESTER RESIN

(71) Applicant: SABIC GLOBAL TECHNOLOGIES B.V., Bergen op Zoom (NL)

(72) Inventors: Johannes Peter Antonius Martens, Geleen (NL); Lidia Jasinska-Walc, Veldhoven (NL); Robbert Duchateau, Roostenlaan (NL); Miloud Bouyahyi, Eindhoven (NL)

(21) Appl. No.: 17/785,683

(22) PCT Filed: Dec. 10, 2020
(86) PCT No.: PCT/EP2020/085453

§ 371 Date: Jun. 15, 2022

(30) Foreign Application Priority Data
Dec. 19, 2019 (EP) 19218227.7

(51) Int. Cl. C08L 23/12; C08G 63/183; C08L 51/06; C08J 3/22; C08J 3/12; B29C 48/00; B29C 48/40

(52) U.S. Cl. CPC C08L 23/12; C08G 63/183; C08L 51/06; C08J 3/226; C08J 3/12; B29C 48/022; B29C 48/40; C08L 2205/08; C08L 2203/30; B29K 2023/12

(57) ABSTRACT

The invention relates to a resin comprising A) a polyolefin, B) a polyester and C) a compatibilizer which is a transesterified product of a functionalized polyolefin containing hydroxyl functional groups and a polyester and to a process to do such resin.

### TECHNICAL FIELD OF THE INVENTION

The present invention relates to a polyolefin resin comprising a polyolefin and a polyester. The invention further relates to a process for making such resin, an article comprising such resin and use of such resin for making an article.

### TECHNOLOGICAL BACKGROUND OF THE INVENTION

Polyolefin and in particular polypropylene homopolymer (PP) are commonly used in constructional plastic parts in particular in automotive industry. Such material benefits in its modulus/impact balance, high surface quality and high chemical resistance against polar organic fluids.

One way to increase the stiffness of PP is using nucleating/reinforcement agent such as mineral fillers like talc. However, using such agent can influence the high surface quality and the impact resistance in the wrong way.

Another way is to include other engineering plastic/polymers within the PP, as for example polyesters such as PET, PBT.

Indeed, A high crystalline engineering plastic like polyesters does have intrinsically a very high modulus but does have a worse impact performance and worse chemical resistance in polar organic fluids.

A blend of those two material polyolefin and polyester should be able to obtain a balance of property in the final compound allowing to have material with high modulus/impact balance, high surface quality and high chemical resistance against polar organic fluids.

However, a compound consisting of a blend of polyolefin and polyester and in particular PP and PET to match the right set of properties is not an option since both separate components are not compatible.

Indeed, polyolefin as PP are apolar and polyester as PET are polar. Therefore each elements of this compound will for clusters/domains containing only polar or apolar polymers, making impossible to reach the wished balance of property by decreasing the overall mechanical properties.

It is an object of the present invention to provide a novel method for the production of polyolefin/polyester resin having a high modulus/impact balance, high surface quality and high chemical resistance against polar organic fluids and overcome the prior art polyolefin/polyester disadvantages in particular but not limited to reduce clusters/domains containing only polar or apolar polymers, in order to have a more homogenous resin.

### SUMMARY

This object is achieved by the present invention by using a compatibilizer, which will be interfacing between the polar and apolar element of the resin in order to reduce clusters/domains containing only polar or apolar polymers of interface allowing to obtain polyolefin/polyester resin having a high modulus/impact balance, high surface quality and high chemical resistance against polar organic fluids than a polyolefin/polyester resin which does not contain such compatibilizer.

In a first aspect, the present invention relates to a process in order to make a polyolefin/polyester resin comprising melt-mixing step with at least a polyolefin A, a polyester B and functionalized polyolefin D containing hydroxyl functional groups,
Wherein
   the total amount of the functionalized polyolefin D containing hydroxyl functional groups with respect to the resin is 2 to 80 wt %; 5 to 80 preferentially 20 to 50.5 wt %; and
   the total amount of the polyester B with respect to the resin is between 20 to 98 wt %; and
   the total amount of the polyolefin A with respect to the resin is between 0 to 78 wt %; 0 to 75 preferentially 29.5 to 60 wt %.

In a second aspect, the present invention relates to a process in order to make a polyolefin/polyester resin comprising a preliminary step in order to create a masterbatch C use as compatibilizer blend and a subsequent step melt-mixing the masterbatch C with a polyolefin A and/or a polyester B,
Wherein the masterbatch comprises
   a functionalized polyolefin D containing hydroxyl functional groups,
   a polyester E and
   a transesterified product of the functionalized polyolefin D containing hydroxyl functional groups and the polyester E.

In some embodiment, the total amount of the polyester B with respect to the resin is between 0 to 19.92 wt %%; and the total amount of the polyolefin A with respect to the resin is between 0 to 78 wt %; and the amount of the functionalized polyolefin D containing hydroxyl functional groups within the compatibilizer blend C is at least 50 wt %, preferentially 50 to 97 wt %, more preferentially 50 to 75 wt %; and the total amount of the functionalized polyolefin D containing hydroxyl functional groups with respect to the resin is 2 to 81 wt %; 5 to 80 preferentially 20 to 50.5 wt %; and the amount of the compatibilizer blend C with respect to the resin is above 2%, advantageously between 10% and 90%, preferentially between 40 to 88 wt %, more preferentially 40 to 70 wt %;

In some embodiment, additives are added with the polyolefin A and/or a polyester B.

In some embodiment, in a final step is an extrusion using an apparatus configured to obtain the resin under a form of pellet or granule having the advantage to be homogenous and well-defined concentration of additives the advantage being a resin with homogeneous and well-defined concentrations of the additives.

In a second aspect, the present invention relates to a polyolefin resin comprising:
polyolefin A and/or a polyester B
and
a compatibilizer blend C comprising
   a functionalized polyolefin D containing hydroxyl functional groups,
   a polyester E and
   a transesterified product of the functionalized polyolefin D containing hydroxyl functional groups and the polyester E;

wherein
the total amount of the polyester B with respect to the resin is between 0 to 19.92 wt %%; and
the total amount of the polyolefin A with respect to the resin is between 0 to 78 wt %; and
the amount of the functionalized polyolefin D containing hydroxyl functional groups within the compatibilizer blend C is at least 50 wt %, preferentially 50 to 97 wt %, more preferentially 50 to 75 wt %; and
the total amount of the functionalized polyolefin D containing hydroxyl functional groups with respect to the resin is 2 to 81 wt %; 5 to 80 preferentially 20 to 50.5 wt %; and
the amount of the compatibilizer blend C with respect to the resin is above 2%, advantageously between 10% and 90%, preferentially between 40 to 88 wt %, more preferentially 40 to 70 wt %;

In some embodiment, the functionalized polyolefin D containing hydroxyl functional groups is prepared by reacting an alkanolamine with a polyolefin formed by grafting a compound comprising an amine-reactive group onto the backbone of a polyolefin.

In some embodiment, the compound comprising the amine-reactive group is selected from the group consisting of ethylenically unsaturated carboxylic acids such as maleic acid, fumaric acid, itaconic acid, acrylic acid, methacrylic acid, and crotonic acid; acid anhydrides such as maleic anhydride and itaconic anhydride; vinyl benzyl halides such as vinyl benzyl chloride and vinyl benzyl bromide; alkyl acrylates and methacrylates such as methyl acrylate, ethyl acrylate, butyl acrylate, lauryl acrylate, methyl methacrylate, ethyl methacrylate, butyl methacrylate, and lauryl methacrylate; and ethylenically unsaturated oxiranes, such as glycidyl acrylate, glycidyl methacrylate, and glycidyl ethacrylate, preferably wherein said compound is maleic anhydride.

In some embodiment, the alkanolamine is selected from the group consisting of ethanolamine, 2-amino-1-propanol, 3-amino-1-propanol, 2-amino-1-butanol and 2-aminobenzyl alcohol, preferably ethanolamine.

In some embodiment, wherein the polyolefin of the functionalized polyolefin D is polypropylene PP, preferentially an i-PP.

In some embodiment, the polyolefin of the functionalized polyolefin D containing hydroxyl functional groups polyolefin is the same type as polyolefin A.

In some embodiment, the polyester E in the compatibilizer blend C is the same type as B.

In some embodiment, the sum of polyolefin A, functionalize polyolefin D and the quantity of polyolefin within the transesterified product with respect to the resin is 80 wt %.

In some embodiment, the sum of polyester B and polyester E within the transesterified product with respect to the resin is 20 wt %.

In some embodiment, the polyolefin A is selected from the group consisting of polypropylene (PP), an PP homopolymer, a low density polyethylene (LDPE), a linear low density polyethylene (LLDPE), a high density polyethylene (HDPE), and an elastomeric copolymer of ethylene and an α-olefin having 4 to 10 carbon atoms, and combinations thereof.

In some embodiment, the polyester B is selected from the group consisting of polyethylene terephthalate (PET) and polybutylene terephthalate (PBT) and a combination thereof.

In some embodiment, the polyester B is a PET, preferentially recycled PET.

In some embodiment, the resin has at least one, preferably two, advantageously three, more advantageously four, most preferably all, of the following requirements:
a tensile modulus of at least 2000 MPa according to ISO 527-2/5A:1993 at 23° C. and/or a stress at break of at least 42 MPa, according to ISO 527-2/5A:1993 at 23° C. and
a Izod impact strength of at least 1.7 KJ/m² according to ISO 180/4A:1993 at 23° C.
A gloss of at least 79 GU according to ISO2813 at a measurement angle of 60°
A flexural modulus of at least 1940 MPa according to ASTM D-790, 23° C.
A flexural strength of at least 57 MPA according to ASTM D-790, 23° C.

In a final aspect, the present invention relates to an article comprising a resin resulting from a process according to invention, or a resin according to invention, preferably, the article is an injection-molded article.

It is noted that the invention relates to all possible combinations of features/embodiments described herein, preferred in particular are those combinations of features that are present in the claims. It will therefore be appreciated that all combinations of embodiments; features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous as it offers a simpler, more economical process for the preparation of the product/composition. Similarly, it is also to be understood that a description on a process comprising certain steps also discloses a process consisting of these steps. The process consisting of these steps may be advantageous as it offers a simpler, more economical process.

When values are mentioned for a lower limit and an upper limit for a parameter, ranges made by the combinations of the values of the lower limit and the values of the upper limit are also understood to be disclosed.

### DETAILED DESCRIPTION

The present invention relate to a polyolefin resin comprising:
A polyolefin A and/or a polyester B; and
a compatibilizer blend C.

The compatibilizer is a blend comprising:
a functionalized polyolefin containing hydroxyl functional groups,
a polyester and
a transesterified product of the functionalized polyolefin containing hydroxyl functional groups and the polyester (which can be block copolymer or graft copolymer).

Preferably, functionalized polyolefin containing hydroxyl functional groups or a mix of functionalized containing hydroxyl functional groups and non functionalized polyolefin is the main polymer in the resin. Accordingly, preferably, the amount of polyolefin A and/or functionalized polyolefin containing hydroxyl functional groups with respect to the resin is greater than the amount of polyester with respect to the resin.

Preferably, the polyolefin resin is a polypropylene resin. Thereby the main polymer in the resin is either a mix of functionalized and non functionalized polypropylene; or functionalized containing hydroxyl functional groups polypropylene.

A) Polyolefin A

The amount of A) with respect to the resin is typically 0 to 78 wt %, preferably between 30 to 78 wt %, more preferably 30 to 60 wt %.

Preferably, however, polyolefin is the main polymer in the resin. Accordingly, preferably, the amount of A) with respect to the resin is greater than the amount of B) with respect to the resin.

Preferably, the amount of A) with respect to the resin is at least 50 wt %, preferably at least 75 wt %, more preferably 80 wt %.

For example, the amount of A) with respect to the resin is 75 to 94 wt %, 80 to 94 wt % or 85 to 92 wt %. The properties of the resin of these embodiments having a major amount of polyolefin allow it to be used in applications where polyolefin has been used.

Examples of the polyolefin include polypropylene (PP), an PP homopolymer, a low density polyethylene (LDPE), a linear low density polyethylene (LLDPE), a high density polyethylene (HDPE), and an elastomeric copolymer of propylene/ethylene and an α-olefin having 4 to 10 carbon atoms, or combinations thereof

The polyolefin may have a density of 0.850 to 0.970 g/cm³ determined according to ISO1183.

PP

With polypropylene as used herein is meant propylene homopolymer or a copolymer of propylene with an α-olefin, for example an α-olefin chosen from the group of α-olefin having 2 or 4 to 10 C-atoms, for example ethylene, for example wherein the amount of α-olefin is less than 10 wt % based on the total propylene copolymer.

Polypropylene can be made by any known polymerization technique as well as with any known polymerization catalyst system. Regarding the techniques, reference can be given to slurry, solution or gas phase polymerizations; regarding the catalyst system reference can be given to Ziegler-Natta, metallocene or single-site catalyst systems. All are, in themselves, known in the art.

Preferably, the tensile modulus of the PP ranges from 800 to 1800 MPa, determined according to ASTM D790A.

Preferably, the tensile modulus of the PP homopolymer having a tensile modulus of 1500 to 1800 MPa, more preferentially 1750 MPa determined according to ASTM D790A.

Preferably, the melt flow index of the PP as determined using ASTM D1238 (230° C./2.16 kg) ranges from 0.3 to 50 dg/min.

LDPE, LLDPE and HDPE

The production processes of LDPE, LLDPE and HDPE are summarised in Handbook of Polyethylene by Andrew Peacock (2000; Dekker; ISBN 0824795466) at pages 43-66. The catalysts can be divided in three different subclasses including Ziegler Natta catalysts, Phillips catalysts and single site catalysts. The latter class is a family of different classes of compounds, metallocene catalysts being one of them. As elucidated at pages 53-54 of said Handbook a Ziegler-Natta catalysed polymer is obtained via the interaction of an organometallic compound or hydride of a Group I-Ill metal with a derivative of a Group IV-VIII transition metal. An example of a (modified) Ziegler-Natta catalyst is a catalyst based on titanium tetra chloride and the organometallic compound triethylaluminium. A difference between metallocene catalysts and Ziegler Natta catalysts is the distribution of active sites. Ziegler Natta catalysts are heterogeneous and have many active sites. Consequently polymers produced with these different catalysts will be different regarding for example the molecular weight distribution and the comonomer distribution.

LDPE

The LDPE may be an ethylene homopolymer or may comprise a comonomer, for example butene or hexene.

Preferably, the LDPE has a density of 0.916 to 0.940 g/cm³, more preferably 0.920 to 0.930 g/cm³, determined according to ISO1183.

Preferably, the LDPE has a Melt flow index of 0.1 to 10.0 g/10 min, more preferably 1.0 to 5.0 g/10 min, determined according to ASTM D1238 (190° C./2.16 kg).

The LDPE may be produced by use of autoclave high pressure technology or by tubular reactor technology.

In some embodiments, the polyolefin in the resin according to the invention is an LDPE having a density of 0.916 to 0.940 g/cm³ determined according to ISO1183 and a Melt flow index of 0.1 to 10.0 g/10 min determined according to ASTM D1238 (190° C./2.16 kg) and the amount of the LDPE in the resin is 5 to 15 wt %. Such resin may have a high gloss, a high MVR and a high tensile modulus while having acceptable impact strength and shrinkage.

LLDPE

The LLDPE may be an ethylene homopolymer or may be a polyethylene copolymer comprising ethylene and a C3-C10 alpha-olefin comonomer (ethylene-alpha olefin copolymer). Suitable alpha-olefin co monomers include 1-butene, 1-hexene, 4-methyl pentene and 1-octene. The preferred comonomer is 1-hexene. Preferably, the alpha-olefin co monomer is present in an amount of about 5 to about 20 percent by weight of the ethylene-alpha olefin copolymer, more preferably an amount of from about 7 to about 15 percent by weight of the ethylene-alpha olefin copolymer.

Preferably, the density of the LLDPE may range between 0.915 g/cm³ and 0.940 g/cm³, preferably 0.930 to 0.940 g/cm³, determined according to ISO1183.

Preferably, the melt flow index of the LLDPE ranges from 0.1 to 5.0 g/10 min, for example from 0.5 to 4.0 g/10 min, for example from 1.0 to 3.0 g/10 min, determined according to ASTM D1238 (190° C./2.16 kg).

The technologies suitable for the LLDPE manufacture include but are not limited to gas-phase fluidized-bed polymerization, polymerization in solution, and slurry polymerization.

According to a preferred embodiment of the present invention the LLDPE has been obtained by gas phase polymerization in the presence of a Ziegler-Natta catalyst. According to another preferred embodiment, the LLDPE may be obtained by gas phase polymerization in the presence of a metallocene catalyst.

In some embodiments, the polyolefin in the resin according to the invention is an LLDPE having a density of 0.915 to 0.940 g/cm³ determined according to ISO1183 and a Melt flow index of 0.1 to 5.0 g/10 min determined according to ASTM D1238 (190° C./2.16 kg) and the amount of the LLDPE in the resin is 5 to 15 wt %. Such resin may have a high MVR and a high tensile modulus while having acceptable gloss, impact strength and shrinkage.

HDPE

HDPE may be an ethylene homopolymer or may comprise a comonomer, for example butene or hexene.

Preferably, the HDPE has a density of 0.940 to 0.970 g/cm³, more preferably 0.950 to 0.965 g/cm³, determined according to ISO1183.

Preferably, the HDPE has a Melt flow index of 0.1 to 15.0 g/10 min, more preferably 1.0 to 10.0 g/10 min, measured according to ASTM D1238 (190° C./5 kg).

In some embodiments, the polyolefin in the resin according to the invention is an HDPE having a density of 0.940 to 0.970 g/cm³ determined according to ISO1183 and a Melt flow index of 0.1 to 15.0 g/10 min determined according to ASTM D1238 (190° C./2.16 kg) and the amount of the HDPE in the resin is 5 to 15 wt %. Such resin may have a high gloss, a high MVR, a high tensile modulus and a low shrinkage while having acceptable impact strength.

Elastomeric Copolymer

The polyolefin may be an elastomeric copolymer of ethylene and an α-olefin having 4 to 10 carbon atoms. The α-olefin comonomer in the elastomeric copolymer is preferably an acyclic monoolefin such as 1-butene, 1-pentene, 1-hexene, 1-octene or 4-methylpentene. Most preferably, the elastomeric copolymer is an ethylene-1-octene copolymer.

Preferably, the elastomeric copolymer has a density of 0.850 to 0.910 g/cm³. Preferably, the density of the elastomeric copolymer is 0.865 to 0.910 g/cm³, for example 0.865 to 0.875 g/cm³ according to ASTM D792.

Preferably, the elastomeric copolymer has a melt flow index of 1.0 to 10.0 dg/min, for example 3.0 to 8.0 dg/min, measured in accordance with ASTM D1238 using a 2.16 kg weight and at a temperature of 190° C.

The elastomers may be prepared using methods known in the art, for example by using a single site catalyst, i.e., a catalyst the transition metal components of which is an organometallic compound and at least one ligand of which has a cyclopentadienyl anion structure through which such ligand bondingly coordinates to the transition metal cation. This type of catalyst is also known as “metallocene” catalyst. Metallocene catalysts are for example described in U.S. Pat. Nos. 5,017,714 and 5,324,820. The elastomer s may also be prepared using traditional types of heterogeneous multi-sited Ziegler-Natta catalysts.

Preferably, the amount of ethylene in the elastomer is at least 50 mol %. More preferably, the amount of ethylene in the elastomer is at least 57 mol %, for example at least 60 mol %, at least 65 mol % or at least 70 mol %. Even more preferably, the amount of ethylene in the elastomer is at least 75 mol %. The amount of ethylene in the elastomer may typically be at most 97.5 mol %, for example at most 95 mol % or at most 90 mol %.

In some embodiments, the polyolefin in the resin according to the invention is an elastomeric copolymer of ethylene and an α-olefin having 4 to 10 carbon atoms having a density of 0.850 to 0.910 g/cm³ determined according to ASTM D792 and a Melt flow index of 1.0 to 10.0 g/10 min determined according to ASTM D1238 (190° C./2.16 kg) and the amount of the elastomeric copolymer in the resin is 5 to 15 wt %. Such resin may have a high gloss, a high MVR, a high tensile modulus, a high impact strength and a low shrinkage.

In some embodiments, the polyolefin in the resin according to the invention is an elastomeric copolymer of ethylene and an α-olefin having 4 to 10 carbon atoms having a density of 0.850 to 0.910 g/cm³ determined according to ASTM D792 and a Melt flow index of 1.0 to 10.0 g/10 min determined according to ASTM D1238 (190° C./2.16 kg) and the amount of the elastomeric copolymer in the resin is 15 to 25 wt %. Such resin may have a high gloss, an extremely high impact strength and a low shrinkage while having acceptable MVR and tensile modulus.

B) Polyester

The amount of B) with respect to the resin is typically 5 to 95 wt %.

Preferably, the amount of B) with respect to the resin is at most 40 wt %, preferably at most 35 wt %, more preferably 20 wt %. For example, the amount of the polyolefin with respect to the resin is 5 to 22.5 wt %, 5 to 20 wt %, preferably 6 to 18 wt % or 8 to 15 wt %.

The total amount of A) and B) with respect to the resin is at least 10 wt % and at most 98 wt % with respect to the resin. Preferably, the total amount of A) and B) with respect to the resin is at least 30 wt % and at most 60 wt %, with respect to the resin.

Typically polyester resins include crystalline polyester resins such as polyester resins derived from an aliphatic or cycloaliphatic diol, or mixtures thereof, containing from 2 to about 10 carbon atoms and at least one aromatic dicarboxylic acid. Preferred polyesters are derived from an aliphatic diol and an aromatic dicarboxylic acid and have repeating units according to structural formula (VIII)

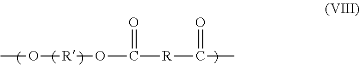

wherein, R′ is an alkyl radical compromising a dehydroxylated residue derived from an aliphatic or cycloaliphatic diol, or mixtures thereof, containing from 2 to about 20 carbon atoms. R is an aryl radical comprising a decarboxylated residue derived from an aromatic dicarboxylic acid. In one embodiment of the present invention the polyester could be an aliphatic polyester where at least one of R′ or R is a cycloalkyl containing radical. The polyester is a condensation product where R′ is the residue of an aryl, alkane or cycloalkane containing diol having 6 to 20 carbon atoms or chemical equivalent thereof, and R is the decarboxylated residue derived from an aryl, aliphatic or cycloalkane containing diacid of 6 to 20 carbon atoms or chemical equivalent thereof. The polyester resins are typically obtained through the condensation or ester interchange polymerization of the diol or diol equivalent component with the diacid or diacid chemical equivalent component.

R′ and R are preferably cycloalkyl radicals independently selected from the following structure IX:

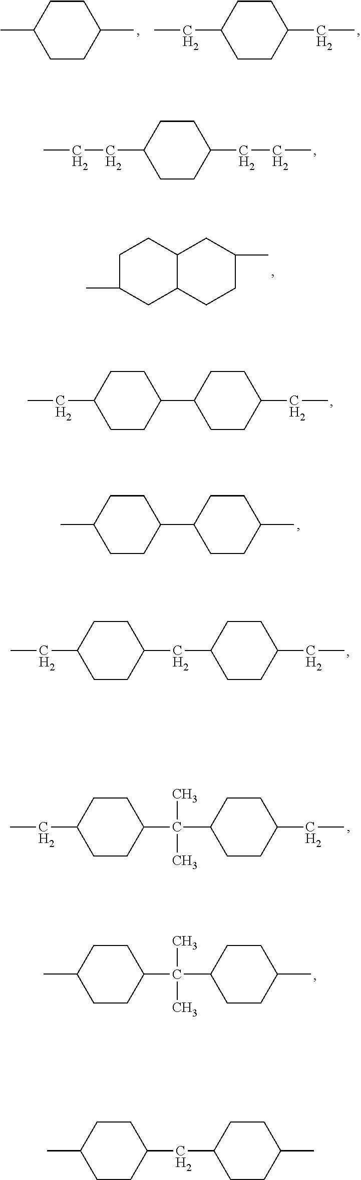

The diacids meant to include carboxylic acids having two carboxyl groups each useful in the preparation of the polyester resins of the present invention are preferably aliphatic, aromatic, cycloaliphatic. Examples of diacids are cyclo or bicyclo aliphatic acids, for example, decahydro naphthalene dicarboxylic acids, norbornene dicarboxylic acids, bicyclo octane dicarboxylic acids, 1,4-cyclohexanedicarboxylic acid or chemical equivalents, and most preferred is trans-1,4-cyclohexanedicarboxylic acid or a chemical equivalent. Linear dicarboxylic acids like adipic acid, azelaic acid, dicarboxyl dodecanoic acid, and succinic acid may also be useful. Chemical equivalents of these diacids include esters, alkyl esters, e.g., dialkyl esters, diaryl esters, anhydrides, salts, acid chlorides, acid bromides, and the like. Examples of aromatic dicarboxylic acids from which the decarboxylated residue R may be derived are acids that contain a single aromatic ring per molecule such as, e.g., isophthalic or terephthalic acid, 1,2-di(p-carboxyphenyl)ethane, 4,4′-dicarboxydiphenyl ether, 4,4′-bisbenzoic acid and mixtures thereof, as well as acids contain fused rings such as, e.g., 1,4- or 1,5-naphthalene dicarboxylic acids. In a preferred embodiment, the dicarboxylic acid precursor of residue R is terephthalic acid or, alternatively, a mixture of terephthalic and isophthalic acids.

Some of the diols useful in the preparation of the polyester resins of the present invention are straight chain, branched, or cycloaliphatic alkane diols and may contain from 2 to 12 carbon atoms. Examples of such diols include but are not limited to ethylene glycol; propylene glycol, i.e., 1, 2- and 1,3-propylene glycol; 2,2-dimethyl-1,3-propane diol; 2-ethyl, 2-methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1, 10-decane diol; and mixtures of any of the foregoing. Preferably, a cycloaliphatic diol or chemical equivalent thereof and particularly 1,4-cyclohexane dimethanol or its chemical equivalents are used as the diol component. Chemical equivalents to the diols include esters, such as dialkylesters, diaryl esters, and the like. Typically the polyester resin may comprise one or more resins selected from linear polyester resins, branched polyester resins and copolymeric polyester resins.

A preferred cycloaliphatic polyester is poly (cyclohexane-1,4-dimethylene cyclohexane-1,4-dicarboxylate) also referred to as poly (1,4-cyclohexane-dimethanol 1,4-dicarboxylate) (PCCD) which has recurring units of formula X:

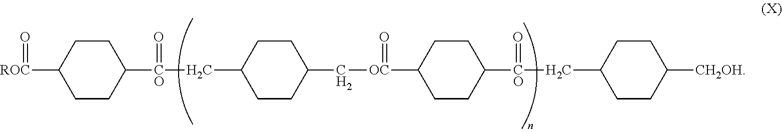

Preferably, the polyester is derived from structural units comprising at least one substituted or unsubstituted aliphatic diols, and/or substituted or unsubstituted cycloaliphatic diol and at least one substituted or unsubstituted aromatic dicarboxylic acid or substituted or unsubstituted aliphatic dicarboxylic acid.

Preferably, the polyester is at least one selected form a group consisting of poly(alkylene phthalate)s, poly(cycloalkylene phthalate)s, poly(alkylene dicarboxylate)s, esteramide copolymers, copolyesters derived from structural units comprising at least one alkyl diol, or cycloaliphatic diol, and at least one aromatic acid, aliphatic acids and cycloaliphatic acids.

Particularly preferably, the polyester comprises polyethylene terephthalate (PET), polybutylene terephthalate (PBT) and/or polycyclohexylenedimethylene terephthalate. Preferably, the polyester comprises PET. Preferably, the polyester in the resin according to the invention consists of PET.

The polyester may be in the form of unused pellet products or recycled (processed) products in the form of flake, pellet or powder, which may be derived e.g. from PET bottles. Preferably, the polyester is a recycled polyester, in particular a recycled PET, for example derived from PET bottles. Preferably the polyester, in particular PET, is dried before being mixed with other components of the resin according to the invention.

The polyester may be bio-based, i.e. the polyester may be a polyester produced from materials or products derived from or made using biological raw materials. Such materials are renewable and are typically obtained from or produced by living organisms such as, for example, plants, trees, algae, bacteria, yeast, fungi, protozoa, insects, animals, and the like. Processes for obtaining diacids from such biomaterials are known to those of skill in the art. Biobased or bioderived difunctional acids are preferred because of a lower ecological footprint associated with production and use of such materials.

Preferably, the polyester, in particular PET, has an intrinsic viscosity (IV) of 0.1 to 1.0 dl/g, for example 0.5 to 0.9 dl/g, as determined by according to ASTM D4603.

Preferably, the polyester, in particular PET, has a melt volume index (MVI) of 5 to 100 dg/min, for example 10 to 50 dg/min, according to ISO 1133 (2.16 kg, 280° C.).

Preferably, the polyester, in particular PET, has a density of at most 1.35 g/cm³ as determined according to ISO 1183. This indicates a lower crystallinity of the polyester, in particular PET, which leads to desirable properties of the final resin.

C) Compatibilizer Blend

The role of the compatibilizer is to decrease the interfacial tension between the immiscible blends of the polar polyester phase and the a-polar polyolefin phase. Addition of the compatibilizer improves adhesion between both phases and stabilizes the morphology of the polyolefin/polyester resin against coalescence, resulting in improved mechanical properties compared to the polyolefin/polyester resin without a compatibilizer.

Finally, the compatibilizer improves the gloss of the resin compared to the polyolefin/polyester resin without a compatibilizer.

The compatibilizer C is a blend comprising:
a functionalized polyolefin containing hydroxyl functional groups,
a polyester and
a transesterified product of the functionalized polyolefin containing hydroxyl functional groups and the polyester (which can be block copolymer or graft copolymer).

The amount of C) with respect to the resin is 2 to 90 wt %, preferentially 15 to 80 wt %, more preferentially 40 to 70 wt %.

A higher amount of compatibilizer leads to a better flexural, gloss, impact strength and/or tensile properties that a similar resin without compatibilizer and therefore the amount of C) in the resin is preferably 40 to 88 wt %, more preferably 40 to 70 wt % with respect to the resin

The total amount of the functionalized polyolefin containing hydroxyl functional groups with respect to the resin is 2 to 80 wt %; preferentially 20 to 50 wt %.

Functionalized Polyolefin Containing Hydroxyl Functional Groups

A functionalized polyolefin containing hydroxyl functional groups is per se known and can be prepared in various known ways.

Preferably, the functionalized polyolefin containing hydroxyl functional groups is prepared by reacting an alkanolamine with a grafted polyolefin formed by grafting a compound comprising an amine-reactive group onto the backbone of a polyolefin

The term “amine-reactive group” as used refers to a chemical group or chemical moiety that can react with an amine group.

The method of the preparation of such hydroxyl functionalized polyolefin is per se known and described in detail e.g. in US20100143651, part of which is incorporated hereinbelow.

Examples of the amine-reactive group include anhydride groups, ester groups and carboxylic acid groups. Most preferably, the amine-reactive group is an anhydride group.

Examples of the compound comprising an amine-reactive group to be grafted onto the backbone of a polyolefin include ethylenically unsaturated carboxylic acids such as maleic acid, fumaric acid, itaconic acid, acrylic acid, methacrylic acid, and crotonic acid; acid anhydrides such as maleic anhydride and itaconic anhydride; vinyl benzyl halides such as vinyl benzyl chloride and vinyl benzyl bromide; alkyl acrylates and methacrylates such as methyl acrylate, ethyl acrylate, butyl acrylate, lauryl acrylate, methyl methacrylate, ethyl methacrylate, butyl methacrylate, and lauryl methacrylate; and ethylenically unsaturated oxiranes, such as glycidyl acrylate, glycidyl methacrylate, and glycidyl ethacrylate.

Preferred ethylenically unsaturated amine-reactive compounds include maleic anhydride, acrylic acid, methacrylic acid, glycidyl acrylate, glycidyl methacrylate.

Most preferably, the compound comprising an amine-reactive group is maleic anhydride.

Suitable examples of the polyolefin of the grafted polyolefin include those described as component A).

In some preferred embodiments, the polyolefin of the grafted polyolefin (PP) is a propylene homopolymer or an i-PP or a copolymer of propylene with an α-olefin, for example an α-olefin chosen from the group of α-olefin having 2 or 4 to 10 C-atoms, for example ethylene, for example wherein the amount of α-olefin is less than 10 wt % based on the total propylene copolymer. The tensile modulus of the PP ranges from 800 to 1800 MPa, determined according to ASTM D790A. Preferably, the tensile modulus of the PP homopolymer having a tensile modulus of 1500 to 1800 MPa, more preferentially 1750 MPa determined according to ASTM D790A. Preferably, the melt flow index of the PP as determined using ASTM D1238 (230° C./2.16 kg) ranges from 0.3 to 50 dg/min.

In some preferred embodiments, the polyolefin of the grafted polyolefin is an LLDPE, for example having a comonomer of 1-octene. The LLDPE may e.g. have a Melt flow index of 10 to 30 g/10 min determined according to ASTM D1238 (190° C./2.16 kg) and a density of 0.860 to 0.900 g/cm³ determined according to ISO1183. The LLDPE may e.g. have a Melt flow index of 0.1 to 10 g/10 min determined according to ASTM D1238 (190° C./2.16 kg) and a density of 0.900 to 0.915 g/cm³ determined according to ISO1183.

The amount of the compound reactive with the amino group of the alkanolamine with respect to the grafted polyolefin may e.g. be 0.01 to 10 wt %, for example 0.1 to 5 wt %, 0.2 to 2 wt % or 0.3 to 1 wt %.

The grafting may be performed by any known method, typically in the presence of a free radical initiator, for example peroxides and azo compounds, or by ionizing radiation. Organic initiators are preferred, such as any one of the peroxide initiators, for example, dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(tert-butyl peroxy)hexane, lauryl peroxide, and tert-butyl peracetate, t-butyl α-cumyl peroxide, di-t-butyl peroxide, di-t-amyl peroxide, t-amyl peroxybenzoate, 1,1-bis(t-butylperoxy)-3,3,5-trimethylcyclohexane, α,α′-bis(t-butylperoxy)-1,3-diisopropylbenzene, α,α′-bis(t-butylperoxy)-1,4-diisopropylbenzene, 2,5-bis(t-butylperoxy)-2,5-dimethylhexane, and 2,5-bis(t-butylperoxy)-2,5-dimethyl-3-hexyne. A suitable azo compound is azobisisobutyl nitrite.

The grafting may e.g. be performed by mixing the polyolefin with the amine-reactive compound in a melt, e.g. at a temperature of 120 to 260° C., for example 130 to 250° C.

Suitable alkanolamines are those of structure (I):

H₂N—R₁—OH (I),

wherein R1 is a divalent hydrocarbon radical, and preferably a linear hydrocarbon of the formula —(CH₂)ₙ—, where n is 2 to 10, preferably 2 to 8, more preferably from 2 to 6.

Preferably, the alkanolamine is selected from the group consisting of ethanolamine, 2-amino-1-propanol, 3-amino-1-propanol, 2-amino-1-butanol and 2-aminobenzyl alcohol.

The reaction of the alkanolamine with the grafted polyolefin may e.g. be performed by mixing the alkanolamine with the grafted polyolefin in a melt.

Reaction Product of Hydroxyl Functional Polyolefin and Polyester

The compatibilizer may be a reaction product of the hydroxyl functional polyolefin and a polyester.

Suitable examples of the hydroxyl functional polyolefin are described above, preferentially polypropylene (PP), more preferentially an i-PP.

Suitable examples of the polyester of the compatibilizer include those described as component B) preferentially a polyethylene terephthalate (PET) or a polybutylene terephthalate (PBT) more preferentially recycle PET.

The amount of the hydroxyl functional polyolefin with respect to the total of the hydroxyl functional polyolefin and the polyester may e.g. be 50 to 97 wt %, for example 50 to 75 wt %. In some embodiments, the amount of the hydroxyl functional polyolefin with respect to the total of the hydroxyl functional polyolefin and the polyester is 50.2 wt %. In some embodiments, the amount of the hydroxyl functional polyolefin with respect to the total of the hydroxyl functional polyolefin and the polyester is 71.6 wt %.

The total amount of the functionalized polyolefin containing hydroxyl functional groups with respect to the resin is 2 to 95 wt %; preferentially 5 to 90 wt %, more preferably 20 to 50 wt %.

The amount of C) with respect to the resin is 2 to 90 wt %, preferentially 40 to 70 wt %.

The reaction product may be a graft or block copolymer comprising a polyolefin part and a polyester part. The reaction of the polyester and the functionalized polyolefin may be transesterification using a suitable catalyst. Such transesterification is described e.g. in WO17097617. An example of the catalyst is phosphinic acid, diethyl, aluminum salt, which is also typically used as a flame retardant.

The reaction of the polyester and the functionalized polyolefin can be carried out in an organic solvent, for example aliphatic hydrocarbon solvents such as heptane, octane and decaline and aromatic hydrocarbon solvents such as toluene and xylene. Other examples of the organic solvent include dimethylformamide and tetrachloroethane.

The reaction of the polyester and the functionalized polyolefin can be carried out in a melt, such as by reactive melt extrusion. This is advantageous in that the tedious and expensive process of dissolving the functionalized polyolefin in the organic solvent is avoided.

Preferably, the total amount of A), B) and C) with respect to the resin is at least 90 wt %, at least 92 wt %, at least 95 wt %, at least 98 wt %, at least 99 wt %, at least 99.9 wt % or 100 wt %.

D) Additives

The resin according to the invention may further comprise optional components different from the previously mentioned components of the resin, such as additives, wherein the total of the previously mentioned components and the optional components is 100 wt % of the resin. Accordingly, the invention also relates to a resin consisting of the previously mentioned components and the optional components.

The additives may be added at any point, e.g. upon mixing of A), B) and C). Alternatively, when C) is a reaction product of the polyester and the functionalized polyolefin, some or all of the additives may be added upon preparation of C).

The additives may include stabilisers, e.g. heat stabilisers, anti-oxidants, UV stabilizers; colorants, like pigments and dyes; clarifiers; surface tension modifiers; lubricants; flame-retardants; mould-release agents; flow improving agents; plasticizers; anti-static agents; external elastomeric impact modifiers; blowing agents; inorganic fillers such as talc and reinforcing agents; and/or components that enhance interfacial bonding between polymer and filler, such as a maleated polypropylene. Talc may also act as a nucleating agent.

The amount of the additives may e.g. be 0.1 to 5 wt %, for example 0.2 to 1 wt %, based on the resin.

In some embodiments, the resin comprises a flame retardant. An example of the flame retardant is phosphinic acid, diethyl, aluminum salt. Such flame retardant acts as a transesterification catalyst to accelerate the reaction between the polyester and the functionalized polyolefin.

Properties of Resin

Preferably, the resin according to the invention has a tensile modulus of at least 2000 MPa according to ISO 527-2/5A:1993.

Preferably, the resin according to the invention has a stress at break of at least 42 MPa, according to ISO 527-2/5A:1993.

Preferably, the resin according to the invention has a Izod impact strength of at least 1.7 KJ/m2 according to ISO 180/4A:1993 (23° C.).

Preferably, the resin according to the invention has a gloss of at least 79 GU according to ISO2813 at a measurement angle of 60°

Preferably, the resin according to the invention has a flexural modulus of at least 1940 MPa according to ASTM D790-10 on 3.2 mm thick specimens prepared according to ISO37/2, in the parallel orientation.

Preferably, the resin according to the invention has a flexural strength of at least 57 MPA according to ASTM D790-10 on 3.2 mm thick specimens prepared according to ISO37/2, in the parallel orientation.

Other Aspects

The resin of the invention may be obtained by a process comprising melt-mixing A), B) and C) and optionally the optional components by using any suitable means. Accordingly, the invention further relates to a process for the preparation of the resin according to the invention comprising melt mixing A), B) and C) and optional components. Preferably, the resin of the invention is made in a form that allows easy processing into a shaped article in a subsequent step, like in pellet or granular form. Preferably, the resin of the invention is in pellet or granular form as obtained by mixing all components in an apparatus like an extruder; the advantage being a resin with homogeneous and well-defined concentrations of the additives.

Suitable conditions for melt-mixing, such as temperature, pressure, amount of shear, screw speed and screw design when an extruder is used are known to the skilled person.

Another embodiment of the invention is an alternative process to obtain such resin in which the process comprising a preliminary step in order to create a masterbatch use as compatibilizer blend and a subsequent step melt-mixing the masterbatch C with a polyolefin A and/or a polyester B and optionally the optional components by using any suitable means.

By creating a masterbatch used as compatibilizer first and after mixing it with the others components of the resin, surprising allows to have better property that melt mixing A), B) and C) and optional components on in one step.

Indeed creating a masterbatch first allows to have a highest amount of transesterified product inside of the compatibilizer blend and therefore improving the distribution of polar and a-polar components within the resin and avoiding to have large domain

The invention further relates to an article comprising the resin according to the invention. Preferably, the article is an injection molded article.

It is noted that the invention relates to all possible combinations of features described herein, preferred in particular are those combinations of features that are present in the claims. It will therefore be appreciated that all combinations of features relating to the resin according to the invention; all combinations of features relating to the process according to the invention and all combinations of features relating to the resin according to the invention and features relating to the process according to the invention are described herein.

It is further noted that the term ‘comprising’ does not exclude the presence of other elements. However, it is also to be understood that a description on a product/resin comprising certain components also discloses a product/resin consisting of these components. The product/resin consisting of these components may be advantageous in that it offers a simpler, more economical process for the preparation of the product/resin. Similarly, it is also to be understood that a description on a process comprising certain steps also discloses a process consisting of these steps. The process consisting of these steps may be advantageous in that it offers a simpler, more economical process.

When values are mentioned for a lower limit and an upper limit for a parameter, ranges made by the combinations of the values of the lower limit and the values of the upper limit are also understood to be disclosed.

The invention is now elucidated by way of the following examples, without however being limited thereto.

Experiments

Following materials were used:
Catalyst Exolit OP1240 from Clariant
Exolit OP1240 is normally used/supplied as a flame retardant, while in current invention it is used as a catalyst for the transesterification process;
iPP-OH synthetized as described below;
PP 500 (PP homopolymer melt flow index (230′C, 2.16 kg=3.1 dg/min)) from SABIC;
AO B225 (Irganox B225) from BASF Polymer Additives;
PET 960 (high IV: intrinsic viscosity of 0.8) from SABIC;
PET 9612 (low IV: intrinsic viscosity of 0.6) from DSM;

Synthesis of Hydroxyl-Functionalized iPP by Reactive Extrusion

iPP-g-MAH (Exxelor:0.43 wt % MAH, 10.0 g, Mₙ=22 kg·mol⁻¹, D=4.4) with Irganox 1010, (used as antioxidant 2500 ppm) was applied into a mini-extruder chamber under nitrogen atmosphere set with three different temperature zone 160° C., 180° C. and 190° C., respectively.

Next ethanolamine (0.08 g, 0.44 mmol) was added through a syringe.

The amount was calculated to the content of anhydride groups (molar ratio of ethanolamine-MAH was equal to 1.1-1).

The Mixture was process for 60 seconds and next the mini-extruder chamber was evacuated.

The OH-functionalized propylene was purified by dissolution in xylenes at 120° C. and precipitation in cold acetone.

Afterwards the product was dried in vacuum oven for 24 h at 40° C.

Preparation of the Compatibilizer Blend

Compatibilizer Blends were prepared by melt-mixing the components as shown in Tables 1 in an extruder a co-rotating twin screw extruder with 11 mm diameter of both screws (100 rpm screw speed, T=260′C, vacuum, 0.2 kg/hr throughput).

TABLE 1
Masterblach of Compatibilizer blend recipes

| Compatibilizer | A | B | C | D | E | F |
|---|---|---|---|---|---|---|
| PP-OH | 50.2 | 71.6 | 91 | 96.2 | 50.2 | 91 |
| catalyst Exolit | 0.3 | 0.3 | 0.3 | 0.3 | 0.3 | 0.3 |
| OP1240 | | | | | | |
| AO B225 | 0.1 | 0.1 | 0.1 | 0.1 | 0.1 | 0.1 |
| PET 960 | | | | | 49.8 | 9 |
| PP 500 | | | | | | |
| PET 9612 | 49.8 | 28.4 | 9 | 3.8 | | |
| Ratio PP-OH/PET | 50/50 | 72/28 | 91/9 | 96/4 | 50/50 | 91/9 |

Preparation of the PP/PET Resin

PP/PET resin were prepared by melt-mixing the components as shown in Tables 2 in a co-rotating twin screw extruder with 11 mm diameter of both screws (100 rpm screw speed, T=260′C, vacuum, 0.4 kg/hr throughput).

After drying the granules, the materials were injection molded into specimen parts in order to measure the properties as shown in Table 3. injection molded conditions are as follow:

Drying Produced PP/PET Compounds:

| | |
|---|---|
| drying temperature [′ C.] | 120 |
| drying time [hrs] | 6 |
| max. moisture content [ppm] | <200 |

Injection Molding (Minimum: 1 kg PP/PET):

| | |
|---|---|
| Rear - Zone 1 temperature [′ C.] | 245 |
| Middle - Zone 2 temperature [′ C.] | 255 |
| Front - Zone 3 temperature [′ C.] | 265 |
| Nozzle temperature [′ C.] | 260 |
| Mold temperature [′ C.] | 60 |
| Type of mold | Babyplast |

The mechanical properties were measured (Table 3) as follows:
Flexural modulus: ASTM D790-10 on 3.2 mm thick specimens prepared according to ISO37/2, in the parallel orientation at 23° C.
Flexural strength: ASTM D790-10 on 3.2 mm thick specimens prepared according to ISO37/2, in the parallel orientation at 23° C.
Izod notched impact strength: ISO 180/4A:1993, 23° C.
Tensile E-modulus: ISO 527-2/5A:1993, 23° C.
Stress at break: ISO 527-2/5A:1993, 23° C.

TABLE 2
Different PP/PET resin recipes comprising the same amount of polyolefins PP 80 wt %
and polyester PET 20 wt %.

| Resin | | Ref. | 1 | 2 | 3 | 4 | 5 | 6 | 7 |
|---|---|---|---|---|---|---|---|---|---|
| iPP-OH | | | | | | | | | |
| PET 960 | | | | | | | | | |
| PP 500 | | 80 | 78 | 78 | 78 | 78 | 78 | 78 | 75 |
| PET 9612 | | 20 | 18.02 | 19.21 | 19.8 | 19.92 | 18.02 | 19.8 | 15.04 |
| A | [%] | | 3.98 | | | | | | 9.96 |
| B | [%] | | | 2.79 | | | | | |
| C | [%] | | | | 2.2 | | | | |
| D | [%] | | | | | 2.08 | | | |
| E | [%] | | | | | | 3.98 | | |
| F | [%] | | | | | | | 2.2 | |
| Screwspeed | [rpm] | 100 | 100 | 100 | 100 | 100 | 100 | 100 | 100 |
| (0-1000 rpm) | | | | | | | | | |
| Throughput (0- | [kg/h] | 0.4 | 0.4 | 0.4 | 0.4 | 0.4 | 0.4 | 0.4 | 0.4 |
| 2.5 kg/h) | | | | | | | | | |
| Resin | | Ref. | 8 | 9 | 10 | 11 | 12 | 13 | 14 |
| iPP-OH | | | | | | | | | 12 |
| PET 960 | | | | | | 12 | 17 | | |
| PP 500 | | 80 | 75 | 60 | 30 | | | 60 | |
| PET 9612 | | 20 | 19.5 | | | | | | |
| A | [%] | | | 40 | | | | | |
| B | [%] | | | | 70 | | | | |
| C | [%] | | 5.5 | | | 88 | | | |
| D | [%] | | | | | | 83 | | |
| E | [%] | | | | | | | 40 | |
| F | [%] | | | | | | | | 88 |
| Screwspeed | [rpm] | 100 | 100 | 100 | 100 | 100 | 100 | 100 | 100 |
| (0-1000 rpm) | | | | | | | | | |
| Throughput (0- | [kg/h] | 0.4 | 0.4 | 0.4 | 0.4 | 0.4 | 0.4 | 0.4 | 0.4 |
| 2.5 kg/h) | | | | | | | | | |

TABLE 3
Mechanical properties of the PP/PET resin

| Resin | | Ref. | 1 | 2 | 3 | 4 | 5 | 6 |
|---|---|---|---|---|---|---|---|---|
| Flexural Properties ASTM D-790 | | | | | | | | |
| Flexural modulus average | MPa | 1902 | 1817 | 1901 | 1860 | 1848 | 1896 | 1900 |
| Flexural modulus stdev | MPa | 23 | 122 | 59 | 92 | 80 | 112 | 108 |
| Flexural strength average | MPa | 56.7 | 56.1 | 57.9 | 57.7 | 57.8 | 59.5 | 58.5 |
| Flexural strength stdev | MPa | 0.2 | 1.4 | 0.9 | 0.8 | 0.7 | 0.2 | 0.6 |
| Gloss (60°) ISO2813 | | | | | | | | |
| Gloss 1 | GU | 77 | 78.7 | 78.9 | 75.1 | 81.6 | 71 | 83.5 |
| Gloss 2 | GU | 83.7 | 78.2 | 82 | 77.7 | 76.4 | 84 | 86.8 |
| Gloss 3 | GU | 78.8 | 86.1 | 87.7 | 80.3 | 84.4 | 77.5 | 86.8 |
| Gloss 4 | GU | 69.8 | 84.4 | 79.1 | 84.3 | 82.2 | 74.5 | 85 |
| Gloss average | GU | 77.325 | 81.85 | 81.925 | 79.35 | 81.15 | 76.75 | 85.525 |
| Izod Impact Strength ISO 180/4A:1993 | | | | | | | | |
| Nominal pendulum energy | J | 1 | 1 | 1 | 1 | 1 | 1 | 1 |
| Izod impact strength average | kJ/m2 | 1.59 | 1.41 | 1.53 | 1.68 | 1.33 | 1.56 | 1.5 |
| Izod impact strength stdev | kJ/m2 | 0.38 | 0.09 | 0.13 | 0.25 | 0.19 | 0.18 | 0.28 |
| Tensile properties ISO 527-2/5A:1993 | | | | | | | | |
| E-modulus average | MPa | 1869.5 | 2062.3 | 1988.5 | 1958.5 | 1987.1 | 2007.3 | 1937.3 |
| E-modulus stdev | MPa | 64.4 | 47.5 | 16.1 | 26.9 | 28.9 | 20.5 | 45.8 |
| Stress at break average | MPa | 40.6 | 40.2 | 42.9 | 42.2 | 42.9 | 43.1 | 42.8 |
| Stress at break stdev | MPa | 0.6 | 4.5 | 2 | 0.3 | 0.6 | 0.2 | 0.6 |

| Resin | | Ref. | 7 | 8 | 9 | 10 | 11 | 12 | 13 | 14 |
|---|---|---|---|---|---|---|---|---|---|---|
| Flexural Properties ASTM D-790C | | | | | | | | | | |
| Flexural modulus average | MPa | 1922 | 1866 | 1990 | 1902 | 1945 | 1863 | 1810 | 1998 | 1748 |
| Flexural modulus stdev | MPa | 30 | 79 | 56 | 23 | 129 | 123 | 110 | 52 | 31 |
| Flexural strength average | MPa | 54.4 | 57 | 58.5 | 56.7 | 58.9 | 47.7 | 50.2 | 59.2 | 50.2 |
| Flexural strength stdev | MPa | 0.7 | 0.3 | 0.8 | 0.2 | 1 | 1.6 | 1.5 | 1.2 | 3.7 |
| Gloss (60°) ISO2813 | | | | | | | | | | |
| Gloss 1 | GU | 74.6 | 74.8 | 65.4 | 77 | 77.5 | 84.5 | 82.6 | | |
| Gloss 2 | GU | 75.1 | 62.9 | 65 | 83.7 | 79 | 84.6 | 82.7 | 59.1 | 77.6 |
| Gloss 3 | GU | 77.6 | 80.3 | 66.3 | 78.8 | 79.8 | 83.5 | 84.3 | 61.6 | 83.8 |
| Gloss 4 | GU | 83.6 | 63.3 | 67.3 | 69.8 | 80.5 | 83.9 | 81 | 57.1 | 77.8 |
| Gloss average | GU | 77.725 | 70.325 | 66 | 77.325 | 79.2 | 84.125 | 82.65 | 61.25 | 78.55 |

| Izod Impact Strength ISO 180/4A:1993 | | | | | | | | | | |
|---|---|---|---|---|---|---|---|---|---|---|
| Nominal pendulum energy | J | 1 | 1 | 1 | 1 | 1 | 1 | 1 | 1 | 1 |

| Izod impact strength average | kJ/m2 | 1.62 | 1.52 | 1.86 | 1.59 | 1.94 | 1.59 | 1.59 | 1.79 | 1.53 |
|---|---|---|---|---|---|---|---|---|---|---|
| Izod impact strength stdev | kJ/m2 | 0.3 | 0.15 | 0.28 | 0.38 | 0.25 | 0.07 | 0.06 | 0.25 | 0.03 |
| Tensile properties ISO 527-2/5A:1993 | | | | | | | | | | |
| E-modulus average | MPa | 2018.5 | 1936 | 2167 | 1869.5 | 2173.5 | 2050.5 | 2026.6 | 2178.9 | 1929 |
| E-modulus stdev | MPa | 41.3 | 15.1 | 17 | 64.4 | 26.9 | 16.8 | 40.1 | 43.2 | 24.4 |
| Stress at break average | MPa | 43.1 | 43.6 | 44.3 | 40.6 | 45.7 | 40.9 | 42.1 | 46.5 | 42 |
| Stress at break stdev | MPa | 1.2 | 1.7 | 0.5 | 0.6 | 1 | 0.7 | 2.4 | 1.1 | 1.8 |

As can be understood from Tables 3, each PP/PET resin with a compatibilizer has a better Tensile E-modulus that the reference resin without the compatibilizer and stress at break similar or better that the reference resin.

In addition, surprisingly, it appear that high is the proportion of compatibilizer (Ex 9-13) between 40 to 70% wt % Ex: 9, 10 and 13) the Tensile E-modulus is above 2150 MPa.

Tensile properties are not the only property with is similar or better that the one measured for the reference material, Gloss Flexural properties and Izod Impact Strength are generally improved.

In particular for the samples with higher content of compatibilizer they seem to have a better Izod Impact Strength than the ones with lower compatibilizer content (inferior to 10 wt %).

It is also good to mention that Ex. 10 made of 30 wt % of PP500P and 70 wt % of Compatibilizer blend recipe B successfully reaches to excel all the six measured mechanical properties in comparison of the reference resin.

1. A process of making a polyolefin/polyester resin comprising:
a preliminary step of creating a masterbatch C for use as a compatibilizer blend wherein the masterbatch C comprises:
a functionalized polyolefin D containing hydroxyl functional groups,
a polyester E and
a transesterified product of the functionalized polyolefin D containing hydroxyl functional groups and the polyester E, and
a subsequent step of melt-mixing the masterbatch C with
a polyolefin A selected from the group comprising of polypropylene (PP), an PP homopolymer, a polyethylene, a low density polyethylene (LDPE), a linear low density polyethylene (LLDPE), a high density polyethylene (HDPE), and an elastomeric copolymer of ethylene and an α-olefin having 4 to 10 carbon atoms, and combinations thereof, and/or
a polyester B selected from the group comprising of polyethylene terephthalate (PET) and polybutylene terephthalate (PBT) and a combination thereof,
wherein,
the total amount of the polyester B with respect to the resin is between 0 to 19.92 wt %; and
the total amount of the polyolefin A with respect to the resin is between 0 to 78 wt %; and
the amount of the functionalized polyolefin D containing hydroxyl functional groups within the compatibilizer blend C is at least 50 wt %; and
the total amount of the functionalized polyolefin D containing hydroxyl functional groups with respect to the resin is 2 to 81 wt %; and
the amount of the compatibilizer blend C with respect to the resin is above 2%.

2. The process according to claim 1, wherein additives are added with the polyolefin A and/or a polyester B.

3. The process according to claim 1, wherein in a final step extruding using an apparatus configured to obtain the resin under a form of pellet or granule having the advantage to be homogenous and well-defined concentration of additives the advantage being a resin with homogeneous and well-defined concentrations of the additives.

4. A polyolefin resin comprising:
a polyolefin A selected from the group comprising of polypropylene, homo-polypropylene, co-polypropylene, polyethylene, low density polyethylene, linear low density polyethylene, high density polyethylene, and elastomeric copolymer of ethylene and an α-olefin having 4 to 10 carbon atoms, and combinations thereof,
and/or
a polyester B selected from the group comprising of polyethylene terephthalate (PET) and polybutylene terephthalate (PBT) and a combination thereof,
and
a compatibilizer blend C comprising
a functionalized polyolefin D containing hydroxyl functional groups,
a polyester E and
a transesterified product of the functionalized polyolefin D containing hydroxyl functional groups and the polyester E;
wherein
the total amount of the polyester B with respect to the resin is between 0 to 19.92 wt %; and
the total amount of the polyolefin A with respect to the resin is between 0 to 78 wt %; and
the amount of the functionalized polyolefin D containing hydroxyl functional groups within the compatibilizer blend C is at least 50 wt %; and
the total amount of the functionalized polyolefin D containing hydroxyl functional groups with respect to the resin is 2 to 81 wt %; and
the amount of the compatibilizer blend C with respect to the resin is above 2%, advantageously between 10% and 90%.

5. The polyolefin resin according to claim 4, the functionalized polyolefin D containing hydroxyl functional groups is prepared by reacting an alkanolamine with a polyolefin formed by grafting a compound comprising an amine-reactive group onto the backbone of a polyolefin.

6. The polyolefin resin according to claim 5, wherein the compound comprising the amine-reactive group is selected from the group consisting of:
ethylenically unsaturated carboxylic acids; acid anhydrides; vinyl benzyl halides; alkyl acrylates and methacrylates; and ethylenically unsaturated oxiranes.

7. The polyolefin resin according to claim 5, wherein the alkanolamine is selected from the group consisting of ethanolamine, 2-amino-1-propanol, 3-amino-1-propanol, 2-amino-1-butanol and 2-aminobenzyl alcohol.

8. The polyolefin resin according to claim 1, wherein the polyolefin of the functionalized polyolefin D is a polypropylene.

9. The polyolefin resin according to claim 1, wherein the polyolefin of the functionalized polyolefin D containing hydroxyl functional groups polyolefin is the same type as polyolefin A.

10. The polyolefin resin according to claim 1, wherein the polyester E in the compatibilizer blend C is the same type as B.

11. The polyolefin resin according to claim 1, wherein the sum of polyolefin A, functionalize polyolefin D and the quantity of polyolefin within the transesterified product with respect to the resin is 80 wt %.

12. The polyolefin resin according to claim 1, wherein the sum of polyester B and polyester E within the transesterified product with respect to the resin is 20 wt %.

13. The polyolefin resin according to claim 1, wherein the resin has at least one of the following requirements:
a tensile modulus of at least 2000 MPa according to ISO 527-2/5A:1993 at 23° C. and/or a stress at break of at least 42 MPa, according to ISO 527-2/5A:1993 at 23° C. and
a Izod impact strength of at least 1.7 kJ/m² according to ISO 180/4A:1993 at 23° C.
A gloss of at least 79 GU according to ISO2813 at a measurement angle of 60°
A flexural modulus of at least 1940 MPa according to ASTM D-790, 23° C.
A flexural strength of at least 57 MPa according to ASTM D-790, 23° C.

14. An article comprising the resin according to claim 1.
